(19) United States
(12) Patent Application Publication
(10) Pub. No.: US 2024/0312047 A1
(43) Pub. Date: Sep. 19, 2024

(54) POSITION DETECTION DEVICE, POSITION DETECTION METHOD, AND POSITION DETECTION PROGRAM

(71) Applicant: NIPPON TELEGRAPH AND TELEPHONE CORPORATION, Tokyo (JP)

(72) Inventors: Taiga YOSHIDA, Tokyo (JP); Naoki ITO, Tokyo (JP); Jun SHIMAMURA, Tokyo (JP)

(73) Assignee: NIPPON TELEGRAPH AND TELEPHONE CORPORATION, Tokyo (JP)

(21) Appl. No.: 18/577,966

(22) PCT Filed: Jul. 14, 2021
(86) PCT No.: PCT/JP2021/026510

§ 371 Date: Jan. 9, 2024

(51) Int. Cl. G06T 7/70; G06T 17/00; G06V 10/25

(52) U.S. Cl. CPC G06T 7/70; G06T 17/00; G06V 10/25; G06T 2207/20084; G06V 2201/07

(57) ABSTRACT

There is provided a position detection device that recognizes a presence position of a target object in a three-dimensional space. The device acquires three-dimensional point cloud information of the space and a plurality of images obtained by imaging an area including surroundings of an object in the space from different imaging points. A region detection unit receives, as an input, the plurality of acquired images, determines whether a target object appears in the plurality of images, and detects a region of the object in each of the plurality of images in a case where the target object appears in each of the images. A specifying unit specifies a region of a point cloud corresponding to the target object based on the point cloud information and the region of the object detected in each of the images. A position detection unit specifies a position of the target object in the space by recognizing points corresponding to the target object from the point cloud information of the region specified by the specifying unit.

### TECHNICAL FIELD

The disclosed technique relates to a position detection device, a position detection method, and a position detection program. In particular, the disclosed technique relates to a technique of detecting a position in a three-dimensional space by recognizing a point cloud and a target object appearing in an image.

### BACKGROUND ART

There is a device that acquires shape data of a three-dimensional space by mounting, in a vehicle, various measurement devices called a mobile mapping system (MMS). In a case where light detection and ranging (LiDAR) is used as a measurement device, point cloud data can be acquired. By combining the point cloud data with position information acquired by the Global Positioning System (GPS) or the like, three-dimensional point cloud information of a space can be acquired.

By analyzing the acquired three-dimensional point cloud information, it is possible to acquire an accurate position of a structure on the ground and construct a three-dimensional map with high accuracy. In order to acquire a position of a structure, a recognition technique for recognizing a target object from three-dimensional point cloud data as disclosed in Non Patent Literature 1 is required.

### CITATION LIST

### Patent Literature

Patent Literature 1: JP 2015-095156 A
Patent Literature 2: JP 2016-018444 A

### Non Patent Literature

Non Patent Literature 1: QI, Charles R., et al. Pointnet: Deep learning on point sets for 3d classification and segmentation. In CVPR 2017.
Non Patent Literature 2: QI, Charles R., et al. Frustum pointnets for 3d object detection from rgb-d data. In CVPR 2018.
Non Patent Literature 3: J. Redmon and A. Farhadi. YOLO9000: better, faster, stronger. In CVPR 2017.
Non Patent Literature 4: HE, Kaiming, et al. Deep residual learning for image recognition. In: CVPR 2016.

### SUMMARY OF INVENTION

### Technical Problem

However, processing of large-scale point cloud data requires a very large calculation cost. For this reason, there is a technique of limiting a range of a point cloud to be processed based on a result of two-dimensional image recognition as described in Non Patent Literature 2 and recognizing a position of a target object at high speed.

In the technique described in Non Patent Literature 2, a range of a point cloud in which a target object exists is narrowed down to a range of a quadrangular pyramid in a three-dimensional space that corresponds to a rectangle obtained from a two-dimensional image recognition result. However, since a distance to the target object is unknown, it is necessary to set the point cloud from a shortest measurable distance to a longest measurable distance. As a result, a height of the quadrangular pyramid and a range of the point cloud that can be narrowed down become very large.

In addition, a point cloud within a range of the narrowed quadrangular pyramid includes points extracted from a shielding object in front of the target object, an object or a building behind the target object, or the like. Therefore, it is necessary to perform processing of removing these unnecessary point clouds, which also cause a decrease in accuracy.

The disclosed technique has been made in view of the above points, and is to narrow down a position of a target object in a three-dimensional space by using a result obtained by recognizing the target object from an image even in a case where other objects are included in front of and behind the target object. Therefore, an object of the disclosed technique is to provide a position detection device, a position detection method, and a position detection program capable of detecting a position of a target object from three-dimensional point cloud information at high speed and with high accuracy.

### Solution to Problem

According to a first aspect of the present disclosure, there is provided a position detection device that recognizes a presence position of a target object in a three-dimensional space, the position detection device including: a point cloud acquisition unit that acquires three-dimensional point cloud information of the space; an image acquisition unit that acquires a plurality of images by imaging an area including surroundings of an object in the space from different imaging points; a region detection unit that receives, as an input, the plurality of images acquired by the image acquisition unit, determines whether a target object appears in the plurality of images, and detects a region of the object in each of the plurality of images in a case where the target object appears in each of the images; a specifying unit that specifies a region of a point cloud corresponding to the target object based on the point cloud information and the region of the object detected in each of the images; and a position detection unit that specifies a position of the target object in the space by recognizing points corresponding to the target object from the point cloud information of the region specified by the specifying unit.

According to a second aspect of the present disclosure, there is provided a position detection method of recognizing a presence position of a target object in a three-dimensional space, the position detection method causing a computer to execute a process including: acquiring three-dimensional point cloud information of the space; acquiring a plurality of images by imaging an area including surroundings of an object in the space from different imaging points; receiving, as an input, the plurality of acquired images, determining whether a target object appears in the plurality of images, and detecting a region of the object in each of the plurality of images in a case where the target object appears in each of the images; specifying a region of a point cloud corresponding to the target object based on the point cloud information and the region of the object detected in each of the images; and specifying a position of the target object in the space by recognizing points corresponding to the target object from the point cloud information of the specified region.

According to a third aspect of the present disclosure, there is provided a position detection program that recognizes a presence position of a target object in a three-dimensional space, the position detection program causing a computer to execute a process including: acquiring three-dimensional point cloud information of the space; acquiring a plurality of images by imaging an area including surroundings of an object in the space from different imaging points; receiving, as an input, the plurality of acquired images, determining whether a target object appears in the plurality of images, and detecting a region of the object in each of the plurality of images in a case where the target object appears in each of the images; specifying a region of a point cloud corresponding to the target object based on the point cloud information and the region of the object detected in each of the images; and specifying a position of the target object in the space by recognizing points corresponding to the target object from the point cloud information of the specified region.

### Advantageous Effects of Invention

According to the disclosed technique, it is possible to narrow down a position of a target object in a three-dimensional space by using a result obtained by recognizing the target object from an image even in a case where other objects are included in front of and behind the target object. Therefore, it is possible to detect a position of a target object from three-dimensional point cloud information at high speed and with high accuracy.

### BRIEF DESCRIPTION OF DRAWINGS

FIG. 1 is a block diagram illustrating a hardware configuration of a position detection device.

FIG. 2 is a block diagram illustrating a functional configuration of the position detection device.

FIG. 3 is a diagram explaining an object region of an image.

FIG. 4 is a diagram explaining an object region of a point cloud.

FIG. 5 is a diagram explaining integration of object regions of a point cloud.

FIG. 6 is a flowchart illustrating a flow of position detection by the position detection device.

### DESCRIPTION OF EMBODIMENTS

Hereinafter, an example of an embodiment of the disclosed technique will be described with reference to the drawings. Note that, in the drawings, the same or equivalent components and portions are denoted by the same reference numerals. In addition, dimensional ratios in the drawings are exaggerated for convenience of description, and may be different from actual ratios.

Hereinafter, a configuration of the present embodiment will be described.

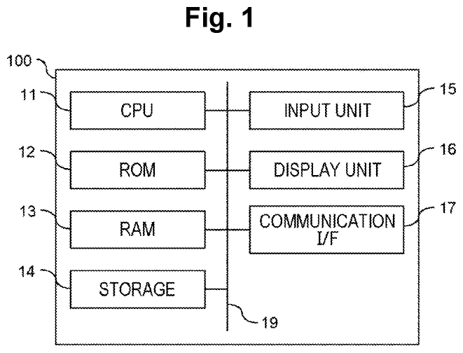

FIG. 1 is a block diagram illustrating a hardware configuration of a position detection device 100.

As illustrated in FIG. 1, the position detection device 100 includes a central processing unit (CPU) 11, a read only memory (ROM) 12, a random access memory (RAM) 13, a storage 14, an input unit 15, a display unit 16, and a communication interface (I/F) 17. The components are communicatively connected to each other via a bus 19.

The CPU 11 is a central processing unit that executes various programs and controls each unit. That is, the CPU 11 reads a program from the ROM 12 or the storage 14, and executes the program by using the RAM 13 as a work area. The CPU 11 controls each component described above and performs various types of calculation processing according to the program stored in the ROM 12 or the storage 14. In the present embodiment, a position detection program is stored in the ROM 12 or the storage 14.

The ROM 12 stores various programs and various types of data. The RAM 13 temporarily stores programs or data as a work area. The storage 14 includes a storage drive such as a hard disk drive (HDD) or a solid state drive (SSD), and stores various programs including an operating system and various types of data.

The input unit 15 includes a pointing device such as a mouse and a keyboard, and is used to perform various inputs.

The display unit 16 is, for example, a liquid crystal display, and displays various types of information. The display unit 16 may function as the input unit 15 by adopting a touchscreen system.

The communication interface 17 is an interface for performing communication with another device such as a terminal. For the communication, for example, a wired communication standard such as Ethernet (registered trademark) or FDDI, or a wireless communication standard such as 4G, 5G, or Wi-Fi (registered trademark) is used.

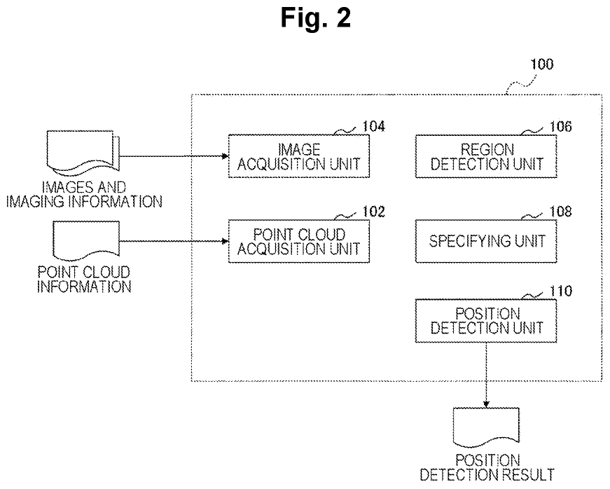

Next, each functional configuration of the position detection device 100 will be described. FIG. 2 is a block diagram illustrating a functional configuration of the position detection device 100 according to the present embodiment. Each functional configuration is achieved in a case where the CPU 11 reads the position detection program stored in the ROM 12 or the storage 14, loads the position detection program in the RAM 13, and executes the position detection program.

As illustrated in FIG. 2, the position detection device 100 includes a point cloud acquisition unit 102, an image acquisition unit 104, a region detection unit 106, a specifying unit 108, and a position detection unit 110.

The point cloud acquisition unit 102 acquires three-dimensional point cloud information in a three-dimensional space (hereinafter, simply referred as a space) using a lidar or the like. The point cloud information acquired in advance may be received as an input.

The image acquisition unit 104 acquires a plurality of images and imaging information by imaging a target object with a camera from different positions. The plurality of images may be imaged by one moving camera, or a plurality of cameras may image a space from different positions. It is assumed that the image is obtained by imaging an area including surroundings of the object in the space. An image acquired in advance may be received as an input. As the imaging information, property information on the imaging device of the images and information for specifying a positional relationship between the image and the three-dimensional point cloud are acquired together. As the property information on the imaging device from which the image is obtained, for example, an imaging angle of view of a camera used for imaging, information for correcting distortion of a lens, and the like can be used. As the information for specifying the positional relationship, for example, information on an imaging position and an imaging direction of the image in a coordinate system of the three-dimensional point cloud can be used.

The plurality of images acquired by the image acquisition unit 104 are input to the region detection unit 106, and the region detection unit 106 detects a region of the object in each image in a case where the target object appears in each of the plurality of images by applying an image recognition technique. Any technique can be used as the image recognition technique, and for example, the technique described in Non Patent Literature 3 can be used. The image recognition technique is obtained by performing learning in advance such that a target object can be recognized. The target object may be a category of an object such as a car or a person, or may be an instance such as a specific vehicle type or a specific person. In addition, a target object to be recognized may be selected from a plurality of target objects.

Further, the region detection unit 106 determines whether or not the target object appears in the plurality of images. In the determination, the region detection unit 106 determines a level of a possibility that the target object appears for each image, based on specifying information that is for specifying an approximate position of the target object and includes map information, the property information, and the information for specifying the positional relationship. An image determined as having a low possibility that the target object appears by the determination is excluded from targets to be processed. Thereby, it is possible to reduce a cost of calculation processing. Note that, in the level determination, a level of a possibility that the target object appears is determined based on a distance from an imaging point of the image to a position possibility range and a ratio of the position possibility range that falls within the angle of view of the imaging device. It is assumed that the position possibility range of the target object is a range within a certain distance from the position of the target object acquired from the map information.

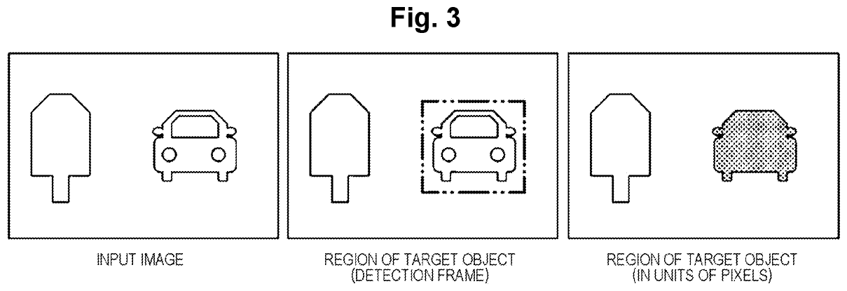

In a case where the target object is recognized by the image recognition, the region detection unit 106 outputs a region of the recognized target object in the image. The region has a certain shape, and as illustrated in FIG. 3, the region may be a rectangular detection frame or a set of pixels corresponding to the target object.

In a case where the target object is an object such as a car, a plurality of target objects may exist in the space. Therefore, whether the target objects recognized in each image are the same object may be determined, and subsequent processing may be separately performed for each object. For the determination as to whether the target objects are the same object, for example, based on the imaging position of the image, in a case where the imaging position is within a certain range, the target objects can be regarded as the same object. In a case where two or more target objects exist, subsequent processing is performed for each target object. Note that, in a case where it is known that one target object exists in the space, the determination as to whether the target objects are the same object may be omitted.

In addition, the region detection unit 106 can determine whether the target objects recognized in each image are the same object by using, for example, an image recognition technique as described in Patent Literature 1. For example, the region detection unit 106 cuts out an image within the range of the detected object region, and determines, for a pair of the cut-out images, whether the objects have the same feature by using the image recognition technique or the like described in Patent Literature 1. The region detection unit 106 may determine whether the objects are the same by applying geometric verification based on local feature amounts to the pair of cut-out images. In a case where a score of a determination result is equal to or higher than a threshold value, the region detection unit 106 may regard the objects as the same object. Thereby, in a case where a plurality of target objects exist, it is possible to avoid erroneous determination of the object region.

The specifying unit 108 specifies a region of a point cloud by calculating and integrating the object regions for each of the target objects which are determined as the same object and for each of recognition results of the imaging points based on the point cloud information and the regions of the objects detected in each image by the region detection unit 106.

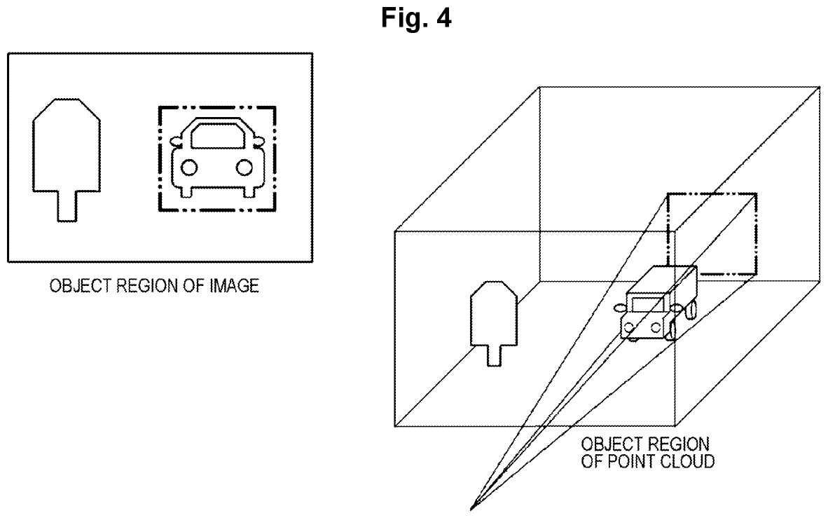

As illustrated in FIG. 4, the object region of the point cloud is generally a pyramid of which a bottom surface has a shape similar to the object region of the image. At this time, points outside a measurement range or a certain range of the point cloud may be excluded from the object region of the point cloud. Further, in a case where the image includes depth information, a region obtained by integrating a space corresponding to the depth information in units of pixels of the object region may be set as the object region of the point cloud.

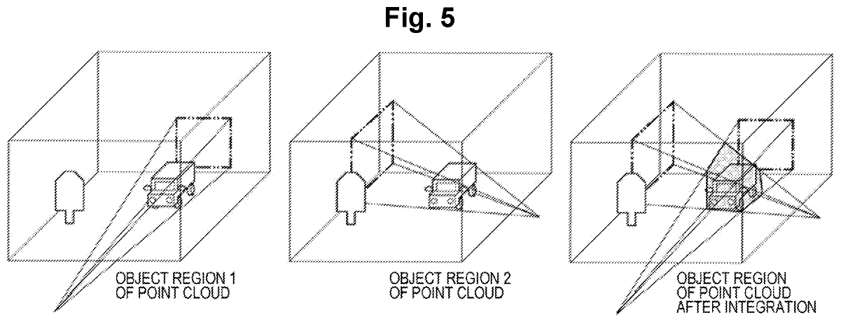

The specifying unit 108 calculates a plurality of object regions for each of recognition results of the same target object, and integrates the plurality of object regions. Thereby, the object region of the point cloud is narrowed down. For example, as illustrated in FIG. 5, in a case where there are two object regions of the point cloud, a portion where the two regions overlap with each other may be set as an integrated region. In addition, a score based on a reliability of the image recognition may be assigned to each object region. In a case where the object is included in a plurality of object regions, the scores of the regions may be summed, and an object region having a score equal to or higher than a threshold value may be set as an integrated region. At this time, a plurality of image recognition techniques may be further applied to the region detected by the region detection unit 106, and a value obtained by weighting and summing the reliabilities of the image recognition results may be set as a score to be assigned to each object region. Further, as the image recognition technique, for example, an image recognition technique based on a convolutional neural network described in Non Patent Literature 4 and an image recognition technique based on local feature amounts described in Patent Literature 2 may be applied. By setting, as a score to be assigned to each object region, a value obtained by weighting and summing the reliabilities of the image recognition results, regions having a score equal to or higher than a threshold value are obtained, and the regions are integrated.

The position detection unit 110 detects an accurate position of the target object in the space by recognizing points corresponding to the target object from the point cloud information of the integrated region that is specified by the specifying unit 108, and outputs a detection result. Further, additional information such as a posture of the target object and a list of points corresponding to the object may be calculated and output as additional information. Any technique can be used for the point cloud recognition of the target object, and for example, the technique described in Non Patent Literature 1 can be used.

Next, an operation of the position detection device 100 will be described.

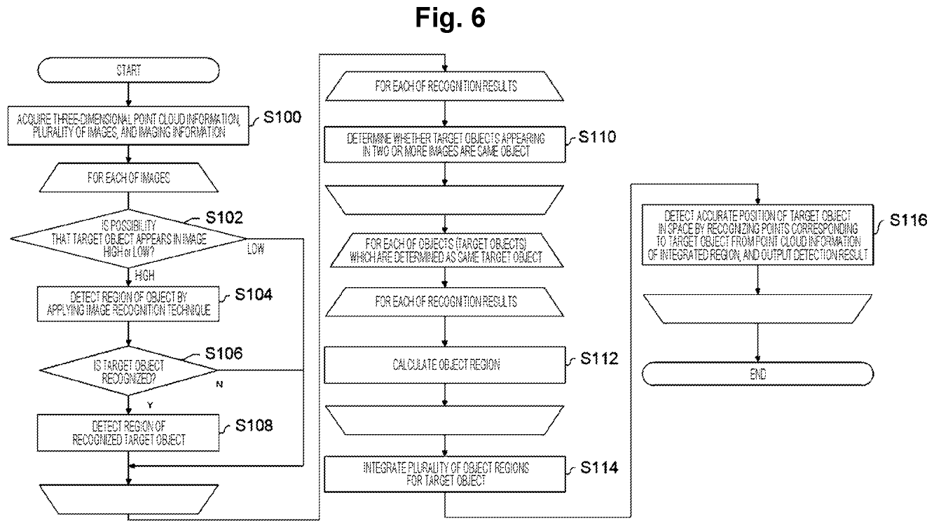

FIG. 6 is a flowchart illustrating a flow of position detection processing by the position detection device 100. In a case where the CPU 11 reads the position detection program from the ROM 12 or the storage 14, loads the position detection program in the RAM 13, and executes the position estimation program, position detection processing is performed. The CPU 11 executes processing of each unit of the position detection device 100.

In step S100, the CPU 11 acquires three-dimensional point cloud information by functioning as the point cloud acquisition unit 102, and acquires a plurality of images and imaging information by functioning as the image acquisition unit 104.

Next, the CPU 11 performs processing of the region detection unit 106. Processing of step S102 to step S108 is performed on each of the plurality of images (each image). Processing of step S110 is performed on a recognition result.

In step S102, the CPU 11 determines, for each of the plurality of images, whether a possibility that the target object appears in the image is high or low. In a case where the possibility is high, the process proceeds to step S104. In a case where the possibility is low, the image is not set as an image recognition target, and is excluded from targets to be processed.

In step S104, the CPU 11 detects a region of an object in each image by applying an image recognition technique.

In step S106, the CPU 11 determines whether or not a target object is recognized. In a case where a target object is recognized, the process proceeds to step S108, and in a case where a target object is not recognized, the image is excluded from targets to be processed.

In step S108, the CPU 11 detects a region of the recognized target object.

In step S110, the CPU 11 determines whether the target objects appearing in two or more images are the same object based on the recognition result. As the determination method, the above-described method is used. In a case where the target objects are not the same object, subsequent processing is separately performed.

Next, the CPU 11 performs processing of the specifying unit 108. Processing after step S110 is performed on each of the target objects, which are determined as the same target object, for each target object. The processing of step S110 is performed for each of recognition results of the objects.

In step S112, the CPU 11 calculates an object region for each of the recognition results.

In step S114, the CPU 11 integrates a plurality of object regions for the target object. As the integration method, the above-described method is used. Thereby, a region of the point cloud of the target object is specified.

In step S116, the CPU 11 functions as the position detection unit 110, detects an accurate position of the target object in the space by recognizing, for the target object, points corresponding to the target object from the point cloud information of the integrated region, and outputs a detection result.

As described above, with the position detection device 100 according to the present embodiment, it is possible to detect the position of the target object from the three-dimensional point cloud information at high speed and with high accuracy.

Note that the position detection processing executed in a case where the CPU reads software (program) in the embodiment may be executed by various processors other than the CPU. Examples of the processors in this case include a programmable logic device (PLD) of which a circuit configuration can be changed after manufacturing, such as a field-programmable gate array (FPGA), and a dedicated electric circuit that is a processor having a circuit configuration exclusively designed for executing specific processing, such as an application specific integrated circuit (ASIC). In addition, the position detection processing may be performed by one of these various processors, or may be performed by a combination of two or more processors of the same type or different types (for example, a plurality of FPGAs, a combination of a CPU and an FPGA, and the like). Further, a hardware structure of the various processors is, more specifically, an electric circuit in which circuit elements such as semiconductor elements are combined.

Further, in the embodiment, the aspect in which the position detection program is stored (installed) in advance in the storage 14 has been described, but the present disclosure is not limited thereto. The program may be provided in a form of a program stored in a non-transitory storage medium such as a compact disk read only memory (CD-ROM), a digital versatile disk read only memory (DVD-ROM), or a Universal Serial Bus (USB) memory. In addition, the program may be downloaded from an external device via a network.

With regard to the embodiment described above, the following appendixes are further disclosed.

### APPENDIX 1

A position detection device including:
a memory; and
at least one processor connected to the memory,
in which, in position detection for recognizing a presence position of a target object in a three-dimensional space,
the processor is configured to
acquire three-dimensional point cloud information of the space,
acquire a plurality of images by imaging an area including surroundings of an object in the space from different imaging points,
receive, as an input, the plurality of acquired images, determine whether a target object appears in the plurality of images, and detect a region of the object in each of the plurality of images in a case where the target object appears in each of the images,
specify a region of a point cloud corresponding to the target object based on the point cloud information and the region of the object detected in each of the images, and
specify a position of the target object in the space by recognizing points corresponding to the target object from the point cloud information of the specified region.

### APPENDIX 2

A non-transitory storage medium storing a program that is executable by a computer to execute a position detection process for recognizing a presence position of a target object in a three-dimensional space, the process including:
acquiring three-dimensional point cloud information of the space;
acquiring a plurality of images by imaging an area including surroundings of an object in the space from different imaging points;
receiving, as an input, the plurality of acquired images, determining whether a target object appears in the plurality of images, and detecting a region of the object in each of the plurality of images in a case where the target object appears in each of the images;
specifying a region of a point cloud corresponding to the target object based on the point cloud information and the region of the object detected in each of the images; and
specifying a position of the target object in the space by recognizing points corresponding to the target object from the point cloud information of the specified region.

### REFERENCE SIGNS LIST

100 Position detection device
102 Point cloud acquisition unit
104 Image acquisition unit
106 Region detection unit
108 Specifying unit
110 Position detection unit

1. A position detection device for recognizing a presence position of a target object in a three-dimensional space, the position detection device comprising a processor configured to execute operations comprising:
acquiring three-dimensional point cloud information of the space;
acquiring a plurality of images of by an area including surroundings of an object in the space according to views from different imaging points;
determining, based on the plurality of images, whether the target object appears in the plurality of images;
detecting a region of the object in each image of the plurality of images, wherein the target object, appears the region in said each image of the plurality of images;
specifying a region of a point cloud corresponding to the target object based on the three-dimensional point cloud information and the region of the object detected in said each image of the images; and
specifying a position of the target object in the space by recognizing points corresponding to the target object from the three-dimensional point cloud information of the specified region.

2. The position detection device according to claim 1, wherein the determining further comprises:
determining a level of a possibility that the target object appears for said each image of the images based on specifying first information and second information, the first information specifies an approximate position of the target object, the first information includes map information, property information on an imaging device of the image, the second information specifies a positional relationship with the point cloud and includes position information and an imaging direction, and the second information excludes the image determined as having a low possibility that the target object appears from targets to be processed.

3. The position detection device according to claim 2,
wherein the determining a level of a possibility further comprises, as a position possibility range of the target object, a range within a predetermined distance from the position of the target object that is acquired from the map information, and
the processor further configured to execute operations comprising determining a level of a possibility that the target object appears based on a distance from an imaging point of the image to the position possibility range and a ratio of the position possibility range that falls within an angle of view of the imaging device.

4. The position detection device according to claim 1,
wherein the determining further comprises determining whether or not the target object corresponds to the same object based on an imaging position of the image or image recognition on the detected object region, and
the specifying a region of a point cloud further comprises specifying a region of the point cloud for the target object by calculating and integrating object regions of the target object for each of target objects which are determined as the same object.

5. The position detection device according to claim 4, wherein the specifying a region of a point cloud further comprises:
assigning a score based on an image recognition result to a respective detected region of the object in said each image of the plurality of images and corresponding to a region of the same target object, and
integrating the object regions having a score equal to or higher than a threshold value.

6. The position detection device according to claim 4, wherein the specifying a region of a point cloud further comprises integrating the object regions by performing, upon a respective detected region of the object in said each image of the plurality of images, image recognition based on a convolutional neural network and image recognition based on local feature amounts and by setting, as a score to be assigned to each of the object regions, a value obtained by weighting and summing reliabilities of image recognition results.

7. A position detection method for recognizing a presence position of a target object in a three-dimensional space, comprising:
acquiring three-dimensional point cloud information of the space;
acquiring a plurality of images by imaging an area including surroundings of an object in the space from different imaging points;
determining whether the target object appears in the plurality of images;
detecting a region of the object in each image of the plurality of images in a case where the target object appears the region in said each image of the plurality of images;
specifying a region of a three-dimensional point cloud corresponding to the target object based on the point cloud information and the region of the object detected in said each image of the plurality of images; and
specifying a position of the target object in the space by recognizing points corresponding to the target object from the three-dimensional point cloud information of the specified region.

8. A computer-readable non-transitory recording medium storing a computer-executable program instructions that when executed by a processor cause a computer to execute operations for recognizing a presence position of a target object in a three-dimensional space, comprising:
acquiring three-dimensional point cloud information of the space;
acquiring a plurality of images by imaging an area including surroundings of an object in the space from different imaging points;
determining whether a target object appears in the plurality of images;
detecting a region of the object in each image of the plurality of images in a case where the target object appears the region in said each image of the plurality of images;
specifying a region of a point cloud corresponding to the target object based on the three-dimensional point cloud information and the region of the object detected in said each image of the plurality of images; and
specifying a position of the target object in the space by recognizing points corresponding to the target object from the three-dimensional point cloud information of the specified region.

9. The position detection device according to claim 2,
wherein the determining further comprises determining whether or not the target object corresponds to the same object based on an imaging position of the image or image recognition on the detected object region, and
the specifying a region of a point cloud further comprises specifying a region of the point cloud for the target object by calculating and integrating object regions of the target object for each of the target objects which are determined as the same object.

10. The position detection device according to claim 3,
wherein the determining further comprises determining whether or not the target object corresponds to the same object based on an imaging position of the image or image recognition on the detected object region, and
the specifying a region of a point cloud further comprises specifying a region of the point cloud for the target object by calculating and integrating object regions of the target object for each of the target objects which are determined as the same object.

11. The position detection method according to claim 7, wherein the determining further comprises:
determining a level of a possibility that the target object appears for said each image of the images based on specifying first information and second information, the first information specifies an approximate position of the target object, the first information includes map information, property information on an imaging device of the image, the second information specifies a positional relationship with the point cloud and includes position information and an imaging direction, and the second information excludes the image determined as having a low possibility that the target object appears from targets to be processed.

12. The position detection method according to claim 11,
wherein the determining a level of a possibility further comprises, as a position possibility range of the target object, a range within a predetermined distance from the position of the target object that is acquired from the map information, and
the processor further configured to execute operations comprising determining a level of a possibility that the target object appears based on a distance from an imaging point of the image to the position possibility range and a ratio of the position possibility range that falls within an angle of view of the imaging device.

13. The position detection method according to claim 7, wherein the determining further comprises determining whether or not the target object corresponds to the same object based on an imaging position of the image or image recognition on the detected object region, and
the specifying a region of a point cloud further comprises specifying a region of the point cloud for the target object by calculating and integrating object regions of the target object for each of target objects which are determined as the same object.

14. The computer-readable non-transitory recording medium according to claim 8,
wherein the determining further comprises:
determining a level of a possibility that the target object appears for said each image of the images based on specifying first information and second information, the first information specifies an approximate position of the target object, the first information includes map information, property information on an imaging device of the image, the second information specifies a positional relationship with the point cloud and includes position information and an imaging direction, and the second information excludes the image determined as having a low possibility that the target object appears from targets to be processed.

15. The computer-readable non-transitory recording medium according to claim 14, wherein the determining a level of a possibility further comprises, as a position possibility range of the target object, a range within a predetermined distance from the position of the target object that is acquired from the map information, and
the processor further configured to execute operations comprising determining a level of a possibility that the target object appears based on a distance from an imaging point of the image to the position possibility range and a ratio of the position possibility range that falls within an angle of view of the imaging device.

16. The computer-readable non-transitory recording medium according to claim 8, wherein the determining further comprises determining whether or not the target object corresponds to the same object based on an imaging position of the image or image recognition on the detected object region, and
the specifying a region of a point cloud further comprises specifying a region of the point cloud for the target object by calculating and integrating object regions of the target object for each of target objects which are determined as the same object.

17. The computer-readable non-transitory recording medium according to claim 8,
wherein the determining further comprises determining whether or not the target object corresponds to the same object based on an imaging position of the image or image recognition on the detected object region, and
the specifying a region of a point cloud further comprises specifying a region of the point cloud for the target object by calculating and integrating object regions of the target object for each of target objects which are determined as the same object.
